(19) United States
(12) Patent Application Publication
(10) Pub. No.: US 2026/0176963 A1
(43) Pub. Date: Jun. 25, 2026

(54) METHODS FOR AUTOMATED CORE-TO-LOG DEPTH MATCHING

(71) Applicant: CGG SERVICES SAS, Massy Cedex (FR)

(72) Inventors: Nguyen LE, Crawley (GB); Edward JARVIS, Abergwyngregyn (GB); David O'CONNOR, Colwyn Bay (GB)

(21) Appl. No.: 19/367,322

(22) Filed: Oct. 23, 2025

Related U.S. Application Data
(60) Provisional application No. 63/737,337, filed on Dec. 20, 2024.

(51) Int. Cl. E21B 47/04; G01V 1/50; G06N 20/00

(52) U.S. Cl. CPC E21B 47/04; G01V 1/50; G06N 20/00; G01V 2210/6169

(57) ABSTRACT

Methods and devices according to various embodiments perform reliable automated core-to-log depth matching. A core-to-log depth matching method includes: (i) pairing a core segment of core property values obtained by analyzing rock samples extracted at core depths from a well and a log segment of log property values obtained from measurements performed with a logging tool at log depths in the well, (ii) for each pair, determining a block-shifting of the core segment relative to the log segment so as to maximize a similarity metric between the core property values and the log property values, and (iii) performing an affine warping based on a tuned set of hyperparameters to adjust length of at least one of core segments.

### BACKGROUND OF THE INVENTION

### Technical Field

Embodiments of the subject matter disclosed herein generally relate to techniques related to petrophysical analysis for exploitation of underground resources. More specifically, the various techniques perform automated core-to-log depth matching for calibration of porosity-permeability transforms, rock typing, and saturation-height functions, and machine-learning models trained on log-core pairs. These techniques sharpen reservoir static property distributions and reduce uncertainty carried into dynamic reservoir simulation and history matching leading to higher confidence field development decisions.

### Discussion of the Background

Geologists and geophysicists use sophisticated techniques such as seismic surveys, gravity and magnetic surveys, exploratory wells, remote sensing, etc. to explore underground formations seeking hydrocarbons (e.g., oil and gas), minerals (precious and base metals, rare earth minerals, etc.) and even water. The exploratory wells are drilled to analyze rock formations, assessing their properties (i.e., various attributes or characteristics). On one hand, a multi-sensor tool (known as logger/logging tool) is lowered in each exploratory wells to measure various properties (e.g., resistivity, gamma ray radiation, temperature, etc.) at multiple depths. Measured and inferred property values (e.g., porosity) as function of log depth are known as log data. On the other hand, rock samples (known as cores) are collected at different depths while drilling the exploratory wells and analyzed to generate core data (e.g. porosity, permeability, fluid saturation, wettability, grain density, capillary pressure, etc. values as function of core depth). Log data and core data may include values for the same property (e.g., porosity) and for distinct properties (e.g., resistivity in the log data and geomechanical properties such as elastic moduli in the core data).

Log data and core data are used to build a structural model of the subsurface formation, that is, identifying and describing material layers pierced by the exploratory wells in the subsurface formation. This structural model may be built either in a traditional approach (i.e., following explicit step-by-step programmed instructions throughout the data processing) or using machine learning-based methods (i.e., employing algorithms designed to learn and improve based on previously processed data without explicit step-by-step instructions).

The core property values are associated with driller's depth values, while the log property values are associated with the logger's depth values. The discrepancy between driller's depth and logger's depth as well as the other differences related to sampling frequency and continuity make core data not readily useable for direct comparison with log data even if the two refer to the same property. Therefore, a core-to-log depth matching is performed to align and shift core sample data and well log data to the same depths. Resolving depth discrepancies that occur during drilling and coring operations leads to reliable petrophysical and reservoir models. Manual depth matching is time-intensive and prone to inconsistency as matching driller's depth to logger's depth almost always requires stretching and squeezing of depth ranges. There have been many attempts to automate core-to-log depth matching but the proposed techniques proved unreliable or plagued by pitfalls requiring manual intervention or cumbersome interpretations.

Thus, there is a need for a reliable automated approach to core-to-log depth matching.

### SUMMARY OF THE INVENTION

Methods and devices according to various embodiments perform automated core-to-log depth matching that pairs and harmonizes the core data and the log data, shifts the core data to align with the log data thereby maximizing their correlation, and fine tunes the resulting matched core-to-log data to compensate for coring process inaccuracies and variations in logging speeds yielding different depth scales.

According to an embodiment, there is a method including pairing a core segment of core property values obtained by analyzing rock samples extracted at core depths from a well and a log segment of log property values obtained from measurements performed with a logging tool at log depths in the well. Here, the core property values and the log property values representing the same subsurface property. The method also includes for each pair, determining a block-shifting of the core segment relative to the log segment so as to maximize a similarity metric between the core property values and the log property values, and performing an affine warping based on a tuned set of hyperparameters to adjust length of at least one of core segments.

According to another embodiments there is a computing system for performing an automated core-to-log depth matching including an input and output interface and a processor. The input and output interface is configured to receive core property values and log property values and output a result of the automated core-to-log depth matching. The processor is connected to the input and output interface and is configured: (i) to perform an initial pairing of a core segment of the core property values obtained by analyzing rock samples extracted at core depths from a well and a log segment of the log property values obtained from measurements performed with a logging tool at log depths in the well, (ii) for each pair, to determine a block-shifting of the core segment relative to the log segment so as to maximize a similarity metric between the core property values and the log property values, and (iii) to perform an affine warping based on a tuned set of hyperparameters to adjust length of at least one of core segments.

### BRIEF DESCRIPTION OF THE DRAWINGS

For a more complete understanding of the present invention, reference is now made to the following descriptions taken in conjunction with the accompanying drawings, in which:

FIG. 1 is a flowchart illustrating an automated core-to-log matching method according to an embodiment.

FIG. 2 is an illustration of portions with and without core data versus depth.

FIG. 3 is a graph of differences between logger and driller's depths versus logger depths.

FIG. 4 illustrates core segment plus margins matching with log segment.

FIG. 5 illustrates core and log segment resample and tie.

FIG. 6 illustrates core segment sliding along the corresponding log segment to create pairs with different lags.

FIG. 7 is a graph of Pearson's correlation coefficient as a similarity metric versus lags.

FIG. 8 illustrates the manner of determining whether the best lag block-shift is significant using the graph of the similarity metric versus lags.

FIG. 9 is a graph illustrating the similarity metric versus lags with upper and lower bounds to the similarity metric values of plural peaks for the same dataset as in FIGS. 7 and 8.

FIG. 10 is a graph illustrating the similarity metric versus lags with upper and lower bounds to the similarity metric values of plural peaks for another dataset.

FIG. 11 illustrates the manner of reconciling overlap after core block-shifting.

FIG. 12 is a graph illustrating data shift.

FIG. 13 is an example of data selection for 3-fold skipping cross-validation.

FIG. 14 is a graph of warp-shifted depth versus block-shifted depth in arbitrary units.

FIG. 15 is a graph illustrating tracking samples between block-shifted and warped data.

FIG. 16 is a block diagram of an apparatus configured to perform the automatic core-to-log depth matching according to an embodiment.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, in the context of log data and cores acquired while drilling an exploratory well.

Before describing various embodiments, various terms are now briefly introduced. Core sample refers to an individual measurement of a certain physical parameter (e.g., gamma radiation emitted by surrounding rocks, which depends on lithology particularly on shale content). Core data refers to core measurements of a certain physical parameter (e.g., gamma radiation values) in a well. Core segment refers to core data and a core depth interval in which core data is regularly acquired (i.e., the core data is characterized by a depth-wise continuity).

Log data refers to log measurements of a certain physical parameter (e.g., gamma radiation values) in a well. Log depths are depth values associated with the log data, respectively. Log segment refers to log data and a log depth interval that covers a core segment plus its margins. The margin is the maximum depth shifting. Block-shifting refers to depth shifting in which a set of depth values are changed by the same amount. A shift conflict occurs when depth shifting results in depth-wise overlap of core segments. Unlike block-shifting, warping refers to depth shifting in which depth steps are potentially changed by different amounts.

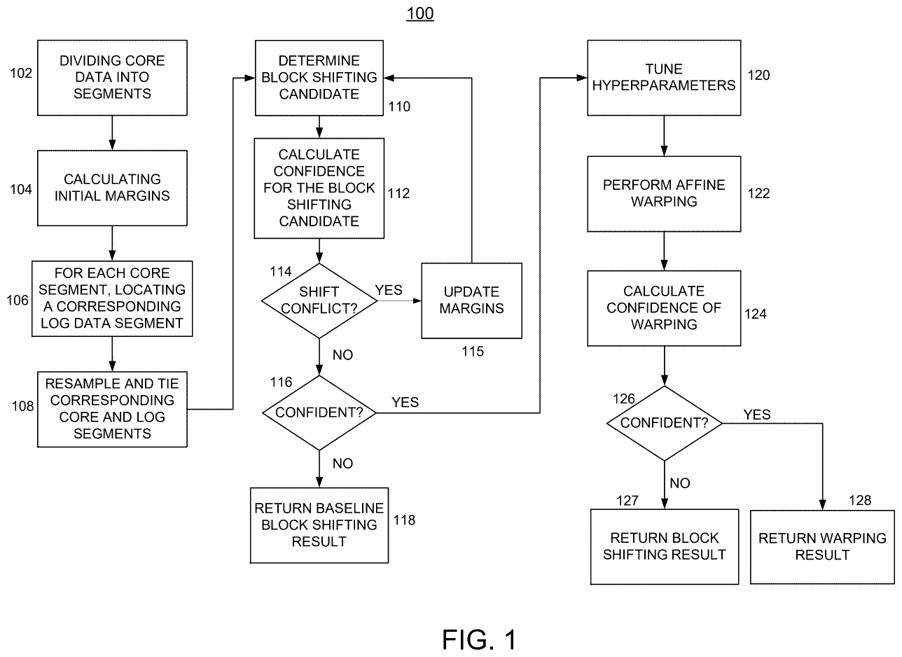

FIG. 1 is a flowchart illustrating an automated core-to-log matching method 100 according to an embodiment. The method 100 may be viewed as having three phases: (a) initial pairing and harmonizing core and log data including steps 102-108, (b) block shifting including steps 110-116, and (c) fine tuning including steps 120-126.

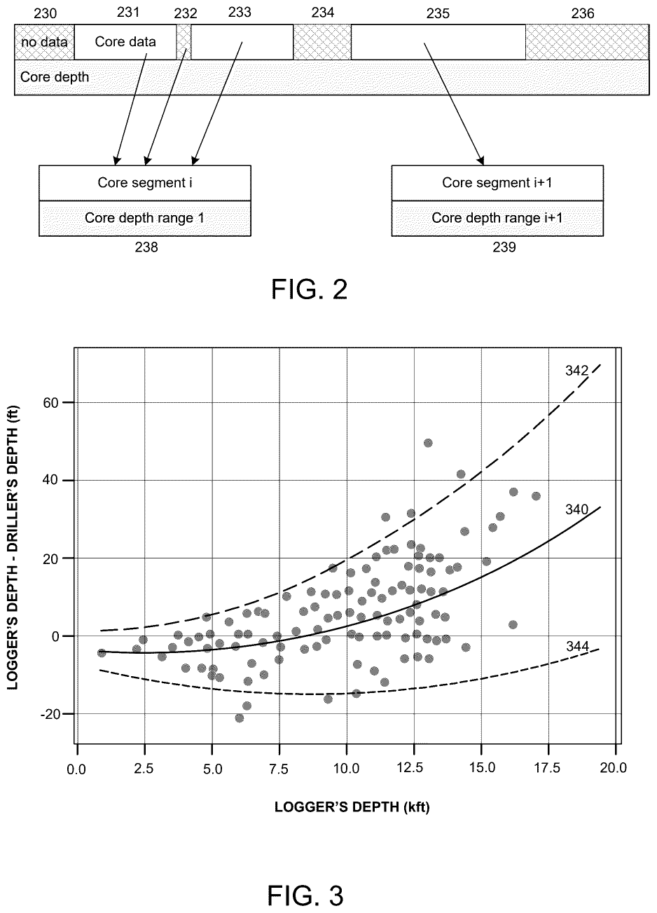

The method 100 starts with dividing 102 core data into segments. As illustrated in FIG. 2, core data are often not acquired continuously depth-wise along the entire well. This means that regularly sampled depth intervals such as 231, 233, and 235 alternate with depth intervals with no core measurements 230, 232, 234 and 236. When a no-core-measurement interval is large (i.e., corresponding to more than a predetermined number of samples), the core data before this no-core-measurement interval pertains to a different core segment than the core data after it. When a no-measurement interval is small (i.e., corresponding to less than the predetermined number of samples) then the no-core-measurement interval is populated with core data generated by interpolating the core measurements adjacent to the no-measurement interval. For example, the predetermined number of sample intervals may be 30. Alternatively, this number may be specified by a user.

In FIG. 2, the regularly sampled depth intervals 231 and 233 together with the no-measurement interval 232 (populated by interpolating the core measurements adjacent to it) form a core segment 238. Next, the regularly sampled depth intervals 235 forms segment 239 because the no-measurement interval 234 is a large interval.

The method 100 continues with calculating 104 initial margins for each core segment. Each core segment has two margins, one above and one bellow the segment, the margins being called left margin and right margin, respectively. The convention regarding shifting segments is increasing depth value means down and decreasing depth value means up. The initial margins (−m and m) of the core segment are calculated as follows.

First, a regression model f (solid line 340) fits a polynomial function to the points representing the difference between logger's depth and driller's depth versus logger's depth (illustrated in FIG. 3). A 95% confidence interval (which is discussed in detail below) of the model f coefficients is calculated to obtain models f_upper and f_lower (dashed lines 342 and 344 in FIG. 3). Then, an absolute value of the initial margin m is evaluated as

$$m = max ( abs ( f\_upper ( d ) , abs ( f\_lower ( d ) ) \qquad ( 1 )$$

The initial left and right margins of each core segment are-m and m serving as the lower and upper limits for block-shifting.

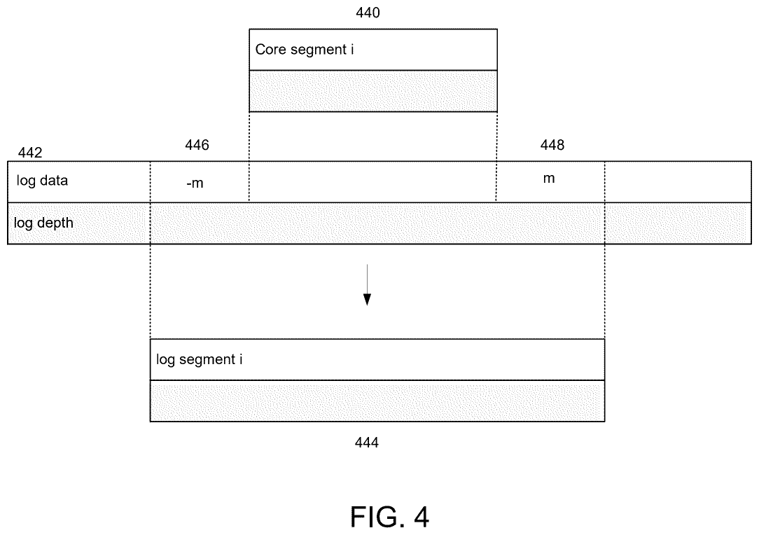

Further, the method 100 continues with locating 106 log segments corresponding to the core segments, respectively, based on the core segment start depth range and the initial margins. The core segment and the log segment refer to values of the same property (e.g., porosity). For example, as illustrated in FIG. 4, the log segment 444 corresponds to the core segment 440. This log segment is a subset of log data 442 that spans a log depth range larger than the core segment 440 extended with the left margin 446 and right margin 448 (i.e., −m and m, respectively).

After locating the log segments corresponding to the core segments (i.e. step 106), the method 100 includes resampling and tying 108 the segments so that both the core segment and the log segment have the same sample rate sr for the core and log data, respectively.

In one embodiment, the sample rate sr is determined in the following manner. For each pair of core segment and log segment, depth increments (i.e., depth differences between consecutive core samples) of the core segment are calculated. If these depth increments are mostly the same, then the core sample rate sr_{core} is set to this depth increment value. Otherwise, the core sample rate sr_{core} is set to the minimum of the depth increments. The log sample rate sr_{log} is calculated in a similar manner. A common sample rate for both the core segment and the corresponding log segment is the smallest of the two sample rates:

$$sr = min ( {sr}_{core} , {sr}_{log} ) . \qquad ( 2 )$$

Alternatively, the common sample rate sr is specified by user.

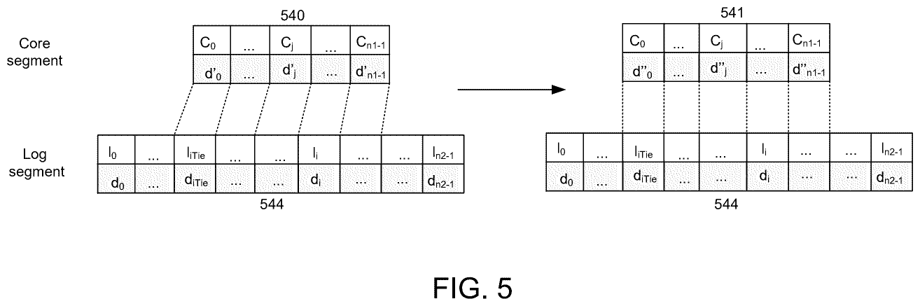

Both the core segment and the log segment then are resampled using the common sample rate sr. The property values Cⱼ with j=0 to n1−1 for the depth intervals d′ⱼ along the core segment 540 are calculated using the nearest value. The property values lᵢ with i=0 to n2−1 for the depth intervals di along the log segment 544 are calculated using interpolation. Although the lengths of the sampling intervals are the same (i.e., the sample rate sr previously determined), the core intervals associated with depths d′ⱼ (and values Cⱼ) are shifted relative to the log depth intervals associated with depths dⱼ (and values lⱼ) as illustrated on the left side of FIG. 5. Therefore, the core depth intervals associated with the core depths d′ⱼ are shifted (to the left in FIG. 5) to correspond to the log depth intervals associated with log depths di yielding core segment 541. The core segment 541 is then tied to the log segment 540 by identifying the log depth d_{iTie} of a log sample interval that is nearest to (or even coincides with) the first (left) core depth d″₀ as shown in the right side of FIG. 5. The log segment d_{iTie} is the depth that corresponds to baseLag (a reference depth).

Looking back to FIG. 1, after the initial core and log data pairing phase (steps 102-108 described above), the method 100 continues with the block shifting phase (including steps 110-116). At 110, a similarity metric is calculated to determine a block-shift yielding a highest similarity metric value when the core segment relative is shifted relative to the log segment by an integer number of common-sample-rate depth intervals (called “bestLag”). The confidence in block-shifting at the bestLag is then assessed 112 (i.e., the block shifting is validated) based on variabilities of similarity metric values (e.g., by determining whether the bestLag is significant relative to the baseLag and other local similarity metric peaks). If a shift conflict related to margins (i.e., an overlap of shifted core segments) is detected 114, the margins are updated 115 and steps 110 and 112 are repeated. The confidence in the bestLag shift is then assessed 116 based on variability calculated for the similarity metric values for few lags. If not confident in the bestLag shift then the method 100 ends by returning 118 the result of the initial core and log data pairing phase (i.e., baseLag).

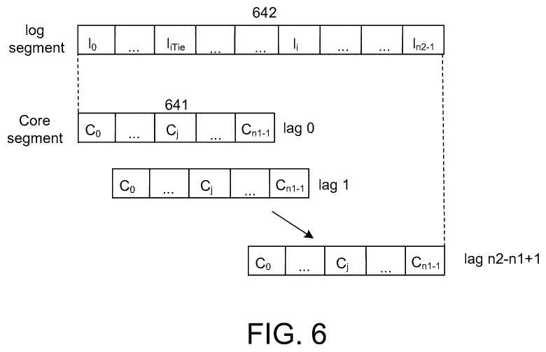

For each core segment and its corresponding log segment, the method 100 performs block-shifting with the starting margins as follows. As illustrated in FIG. 6, the core segment data 640 (i.e., property values C₀ to Cₙ₁₋₁) is paired successively with portions of the log segment data 642 (i.e., property values Iₖ to Iₖ₊ₙ₁₋₁). The distance in sampling rate intervals between the beginning of the log segment and the beginning of the core segment for each pair is k called “lag” and takes values between 0 and n2-n1+1). Thus, a first pair made of the core data and a first portion of the log data is labeled “lag 0” (with the core sample property value C₀ corresponding to the log sample property value I₀), the second pair made of the core data and a second portion of the log data is labeled “lag 1” (when the core sample property value C₀ corresponds to the log sample property value I₁), . . . , and, the last pair made of the core data and an n2−n1+1 portion of the log data is labeled “lag n2−n1+1” (with the core sample property value Cₙ₁₋₁ corresponding to the log sample property value Iₙ₂₋₁).

A similarity metric is then calculated for each pair (lag). Two commonly used similarity metrics are the Pearson's correlation coefficient and the Spearman's correlation coefficient. The Pearson's correlation coefficient is calculated as:

$$ρ ( C , {I}_{lag} ) = \frac{{\sum }_{i = 0}^{n 1 - 1} ( {C}_{i} - \overline{C} ) ( {l}_{i + lag} - \overline{{l}_{lag}} )}{\sqrt{{\sum }_{i = 0}^{n 1 - 1} {( {C}_{i} - \overline{C} )}^{2} {\sum }_{i = 0}^{n 1 - 1} {( {l}_{i + lag} - \overline{{l}_{lag}} )}^{2}}} \qquad ( 3 )$$

where C̅ and l̅_̅{̅l̅a̅g̅}̅ are average values for the respective data portion (the same average C̅ for core data but an average value depending on lag for the log data because different portions thereof likely yield different l̅_̅{̅l̅a̅g̅}̅). The Pearson coefficient's value ranges from −1 to +1 (a value of 1 indicating perfect correlation, a value of −1 indicating anticorrelation, and a value of 0 indicating no correlation).

The Spearman's correlation coefficient (also varying between −1 and 1 with the values having the same significance as Pearson's correlation coefficient) is another statistical measure of the strength and direction of a monotonic relationship between two variables (core data and log data in this case). Unlike the Pearson's correlation coefficient, the Spearman's correlation coefficient uses the rank of the values instead of the values themselves. More specifically, to calculate the Spearman's correlation coefficient, a rank is assigned to each value of the core property values and the log property values respectively, for example based on the values' magnitude order. Differences dk (with k=0 to n1−1) between the ranks of corresponding core and log property values are then calculated. Spearman's correlation coefficient may then be calculated as

$$ρ ( C , {l}_{lag} ) = 1 - \frac{6 {\sum }_{k = 0}^{n 1 - 1} {d}_{k}}{n {1}^{3} - n 1} . \qquad ( 4 )$$

The Pearson's correlation coefficient and the Spearman's correlation coefficients yield similar though not necessarily identical results. Alternatively, another similarity metric may be used.

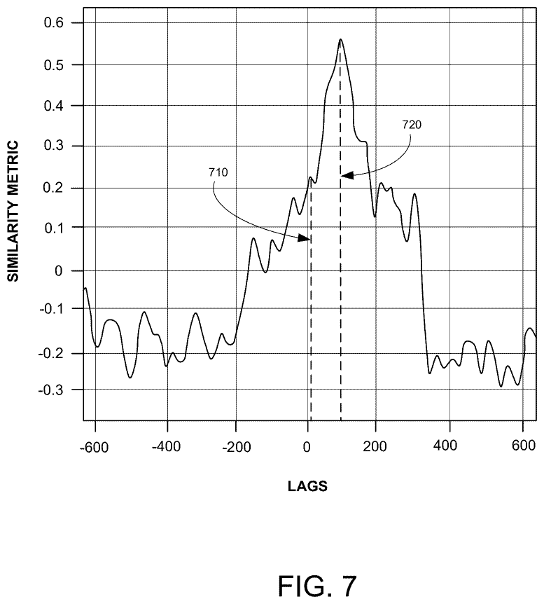

FIG. 7 is a graph of Pearson's correlation coefficient (i.e., a similarity metric) versus lags. The lag corresponding to a log data portion starting with I_{iTie} is the baseLag Tied 710 (a “0” on x axis in FIG. 7). The maximum of the similarity function is bestLag Tied 720 corresponds to a bestLag value of x axis. The product bestLag Tied x sr is the candidate for block shifting.

Further, it is tested whether (i) the candidate block-shift (at bestLag) is significantly better than the baseline block-shift (i.e., at baseLag), (ii) whether there is any shift conflict (i.e., adjacent segments overlap), and (iii) whether the bestLag is significant relative to local peaks of the similarity metric. These tests give confidence that block-shifting according to bestLag reliably improves the core-to-depth matching.

In order to perform these tests, bootstrap distributions of the similarity metric are generated for paired core segment and portion of the log segment at baseLag, bestLag and other points later discussed (peakLags). A bootstrap distribution is the distribution of repeated statistics (like means or medians) generated from multiple, resampled datasets created to replace the original, single sample. The bootstrap distribution is an approximation of a true sampling distribution, allowing to estimate the variability (like standard error) and construct confidence intervals (i.e., an upper bound and a lower bound of the similarity metric values based on variability for a predetermined confidence level). A confidence interval is a range of values calculated for a sample that is likely to contain the true value of a population parameter. The confidence interval is expressed with a specific confidence level (e.g., 99%), which indicates that, if the sampling process were repeated many times, there is the confidence level (e.g., 99%, but may be another default value or may be a value specified by a user) that the calculated confidence intervals contain the true population parameter. To calculate a confidence interval, one (a) finds the sample mean, (b) calculates the margin of error using the sample standard deviation and sample size, and (c) adds and subtracts this margin from the sample mean to get the interval's upper and lower bounds. Thus, the bootstrap distribution allows estimating the variability and uncertainty of a statistic without needing to collect new samples from the entire population.

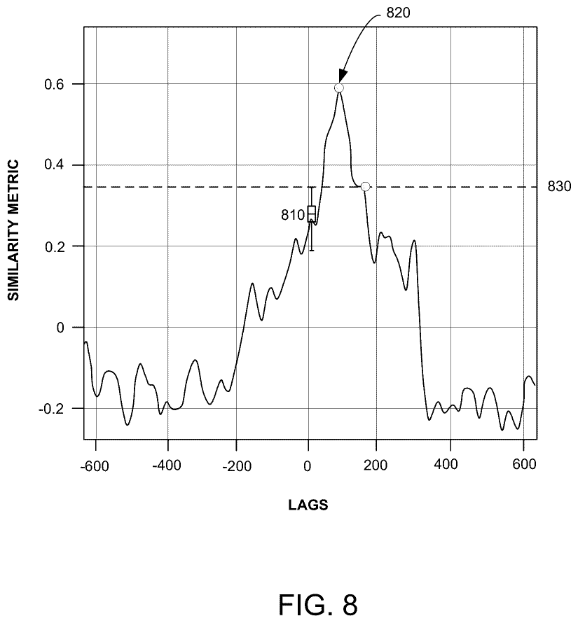

FIG. 8 is a graph illustrating again the similarity metric versus lags (as in FIG. 7) with a margin of error (i.e., the upper and lower bounds calculated using bootstrap distributions) illustrated for the baseline similarity metric value 810 (at baseLag). The block-shift to bestLag is significant if the similarity metric value 820 at bestLag is higher than the upper bound of the baseline confidence interval which is indicated by line 830. For the core and log datasets used for this illustration, the result of test (i) is true. In case, the result of test (i) were negative (the block-shift at bestLag is not significant), the method 100 returns the baseline shifting result.

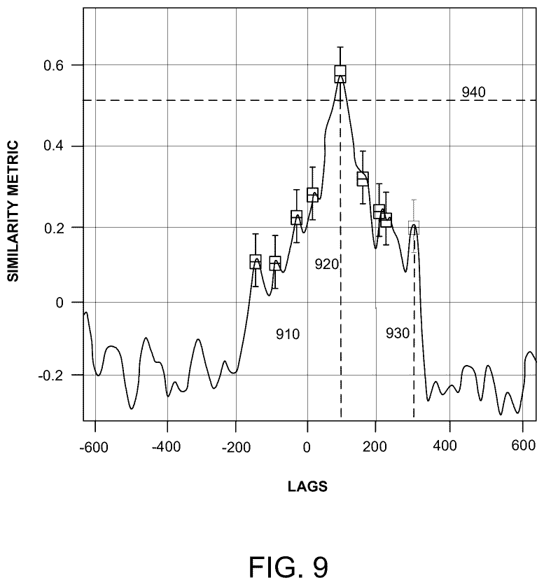

Further, the method 100 tests 112 confidence in the block-shift at bestLag (or baseLag if the bestLag was abandoned) as follows. Additional local peaks (besides the peak corresponding to the highest value of the similarity function at bestLag) are selected using the similarity metric versus lag graph. A predetermined number of additional peaks may be selected based on amplitudes of the local peaks, widths of the local peaks, similarity metric values of the local peaks, etc. As already mentioned above, bootstrap distributions and confidence intervals enable determining upper and lower bounds for the similarity metric values at the bestLag (or baseLag if block shifting to bestLag is abandoned) and peakLags. FIG. 9 is a graph illustrating the similarity metric versus lags for the same dataset as in FIGS. 7 and 8. In this figure, label 910 indicates the baseLag, label 920 indicates the bestLag, and label 930 indicates another peakLag. For this dataset, there is high confidence in the block-shift to bestLag because no upper bound of peaks other than the peak at bestLag exceeds the lower bound of the similarity value at bestLag represented by line 940.

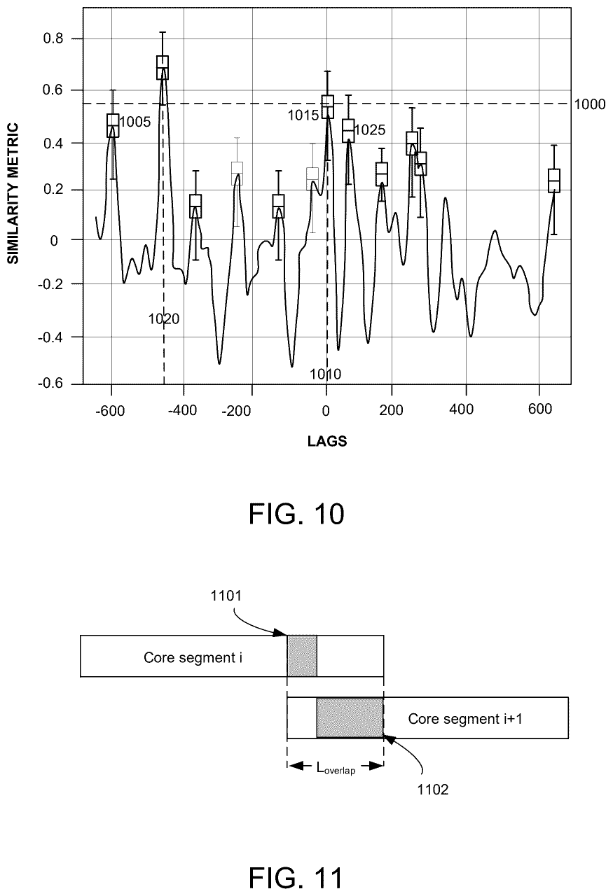

In contrast, FIG. 10 is a graph illustrating the similarity metric versus lags with upper and lower bounds to the similarity metric values of plural peaks for another dataset. Here, the baseLag is labeled 1010 and the bestLag is labeled 1020. The upper bounds of similarity values of peaks 1005, 1015, and 1025 exceed the lower bound of the similarity metric value at the bestLag represented by dashed line 1000. In this case the confidence in the block-shift to bestLag is low.

In order to calculate the confidence in a candidate block-shift, the bootstrap distributions of bestLag and the remaining peakLags are merged into a distribution D. A cumulative distribution functions (CDF) of similarity metrics at bestLag and remaining peakLags with respect to distribution D is then calculated as

$${CDF}_{D} ( d ) = P ( D <= d ) . \qquad ( 5 )$$

with d being any similarity metric at these lags.

A CDF provides the probability P that a random variable will take on a value less than or equal to a given point. It is a non-decreasing function that ranges from 0 to 1 and is essential for determining percentiles and making decisions under uncertainty by summarizing the entire probability distribution of a random variable. CDF_{D} is then normalized by dividing it by the sum of its elements (i.e., the probabilities calculated for the bestLag and remaining peakLags). Confidence of block-shifting to bestLag is the value of normalized CDF_{D} evaluated at bestLag.

The method 100 continues with determining 114 whether the block-shift to bestLag causes a shift conflict that is a depth-wise overlap of adjacent core segments. After block-shifting of the core segments, an overlap may occur between adjacent core segments as illustrated in FIG. 11. Such a situation is reconciled by updating 115 margins of the overlapping core segments using the confidence calculated at 112 as follows. Portions of the overlap length (Lₒᵥₑᵣₗₐₚ) are allocated to the overlapping adjacent core segments. First, a coefficient (weight) is calculated as

$$weight = \frac{{confidence}_{left}}{{confidence}_{left} + {confidence}_{right}} \qquad ( 6 )$$

where confidence_{left} is the confidence for shifting the shallower core segment (i.e., core segment i in FIG. 11) with and confidence_{right} is the confidence for shifting the deeper core segment (i.e., core segment i+1 in FIG. 11).

Then, the initial right margin of the shallower core segment (that included the entire overlap portion) is reduced with

$${margin}_{shallow} = {blockshift}_{shallow} - {L}_{overlap} * ( 1 - weight ) \qquad ( 7 )$$

and the initial left margin of the shallower core segment (that also included the entire overlap portion) is reduced with

$${margin}_{deeper} = {blockshift}_{deeper} - {L}_{overlap} * weight . \qquad ( 8 )$$

Thus, the portion 1101 of the overlap pertains only to the core segment i and portion 1102 of the overlap pertains only to the core segment i+1. On one hand, this technique for estimating start/end of the margins inside the overlap and updating margins of core segments prevents data from being shifted by a physically impossible amount and limits the search space of depth shifting for faster optimization on the other hand.

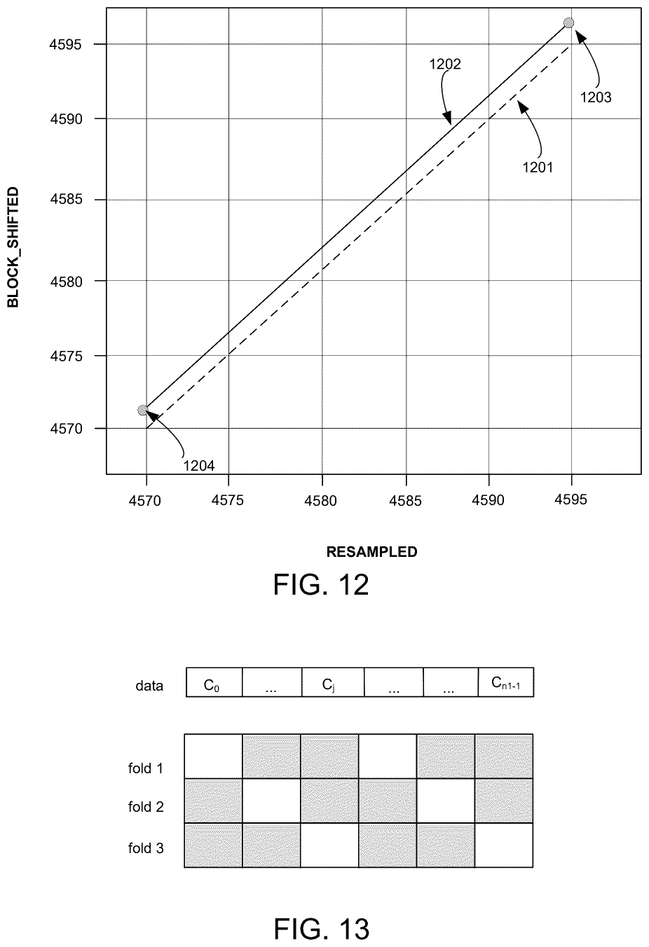

After the margins of the overlapping core segments are updated the method steps 110, 112, and 114 are repeated. Once there is no longer a shift conflict, if the above-calculated confidence exceeds a predetermined threshold (i.e., it is high), the block shifting phase is completed (i.e., the block-shifts are applied to core segments, respectively, and resulting core and log segments are stored). For example, FIG. 12 is a graph illustrating a core segment 1201 being block-shifted to 1202 with end points 1203 and 1204 versus resampled depth (in feet).

The technique for estimating confidence in the block-shifting (1) provides users with a quality metric of shifting quality and (2) serves as a gate keeper to discard spurious shifting result that could arise from purely optimizing for a similarity/error metric.

The difference between logger's depth and driller's depth is often not a constant. Therefore, for core-to-log depth matching, variable-shifting (also known as stretch and squeeze) is often needed after block-shifting. The variable shifting is performed using a constrained dynamic warping algorithm called affine warping (for example, described in the 2020 article “Discovering precise temporal patterns in large-scale neural recordings through robust and interpretable time warping” by A. H. Williams, B. Poole, N. Maheswaranathan, A. K. Dhawale, T. Fisher, C. D. Wilson, D. H. Brann, E. M. Trautmann, S. Ryu, R. Shusterman, and others published in Neuron, 105(2), 246-259).

The method 100 further includes tuning 120 hyperparameters (e.g., number of anchor points, number of iterations, warping regulations etc.) to maximize a similarity metric and/or minimize an error thereof using a skipping cross-validation.

The skipping cross-validation of a similarity metric (e.g., the Pearson's correlation coefficient or Spearman's correlation coefficient) and an error thereof (e.g. a mean squared error, a mean absolute error, or a user-defined error) is performed as follows. The core segment and log segment are split into folds by regularly skipping points. The number of points skipped equals the number of folds. FIG. 13 illustrates a 3-fold skipping in which three subsets of the core data C₀, . . . , Cₙ₁₋₁ called fold 1, fold 2, and fold 3 are generated by grouping the property values in sets of adjacent three values (e.g., {C₀, C₁, C₂,}, {C₃, C₄, C₅}, etc.) and then skipping every first, every second or every third data point, respectively, in each group. In FIG. 13, the skipped values are white, and the values included in the respective fold are grey. The number of folds may be a default value (e.g., 5) or may be specified by the user.

Then, for each set of hyperparameters in the search space set and for each fold, a warping model with the current set of hyperparameters is fit/trained on the rest of the folds. The similarity metric is then calculated for the current fold (i.e., the fold that is not used for fitting/training model). The warping model fitting and similarity metric calculation are repeated across the folds and averaged to obtain a cross-validation score.

Performing automated hyperparameters tuning of affine warping minimizes user input in the process of fitting an affine warping model. After tuning the hyperparameters, the method 100 continues with performing 122 an affine warping. The affine warping is an algorithm that computes an optimal alignment (i.e., warping path) between two sequences (e.g., time series or depth series) with warping path constrained to be only affine transformations (i.e., the geometric transformation that results in a change of shape and position while preserving specific geometric properties (e.g., lines remain lines, parallel lines stay parallel, and the ratios of lengths between parallel line segments are maintained, though the overall angles and distances can change).

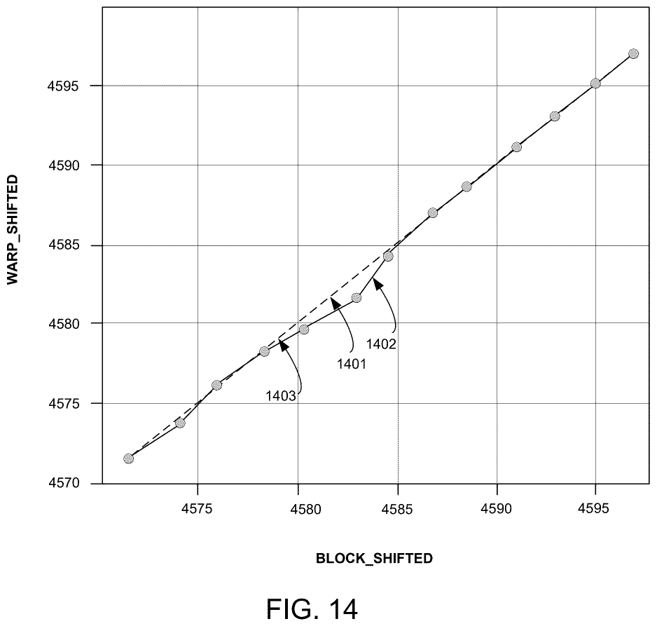

Performing the affine warping includes (1) updating (refitting) the warping model using the tuned set of hyperparameters, (2) performing warping according to the updated warping model, and (3) assessing whether the warping significantly improves core-to-log depth matching output by the block-shifting (obtained at step 120). For example, FIG. 14, which is a graph of warp-shifted depth versus block-shifted depth in arbitrary units, illustrates shifting path of an affine warping model 1401 versus initial block-shifting model 1402. The line segments that are not at 45° are stretched (>45°, e.g., 1402) or squeezed (<45°, e.g., 1403).

In order to trace the shifted core data back to the original data sample by sample, each core sample needs to be tracked. The tracking is updated whenever a depth altering operation is performed (i.e., resampling, block-shifting, warping). This tracking is achieved by linking the indices of depth steps after and before any such operation. Core sample tracking of more than one depth altering operation can be done by superposition these depth step indices.

After resampling, the number of core samples may change as a core sample property values may be duplicated or removed in cases of up-sampling or down-sampling, respectively. The tracking may use the binary search tree algorithm described in the 1975 article “Multidimensional binary search trees used for associative searching” by J. L. Bentley published in Communications of the ACM, 18(9), pp. 509-517. This binary search tree algorithm includes: (i) constructing a binary tree of pre-resampling depth (ii) querying the resampled depth against the pre-resampling depth tree, and (iii) storing the queried indices which represent the initial depth steps nearest to the resampled depth steps.

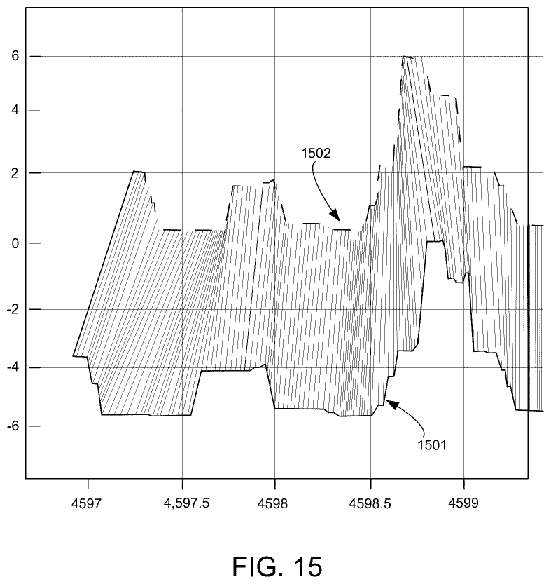

After block-shifting, as the number of core samples does not change, the indices of depth steps before and after block-shifting are the same. After warping, the number of core samples may change (i.e., a value may be duplicated or removed due to stretching or squeezing, respectively). The tracking may be done as described above for resampling. FIG. 15 illustrates tracking of samples between block-shifted 1501 and warped data 1502 (the thin lines representing the correspondences between block-shifted core samples and warped core samples, and the thick lines mark the anchor points).

This approach tracks efficiently each individual core sample from any step of the processing method to the initial data. As the number of queries equals the number of core samples, the time complexity of the tracking technique using binary tree is O(n*log(n)) (including tree construction time) while that of the brute force method is O(n²), with n being the number of core sample values.

Thus, the method 100 performs automatic core-to-log depth matching including depth stretch and squeeze, provides a confidence metric of shifting and allows tracking of individual core sample to the initial data. The method, which implements a two-step shifting (block-shifting and affine warping), is robust yet flexible enough for core-to-log depth matching problem. The use of sliding similarity metrics instead of the conventional approach with cross-correlation coefficients allows the core depth to be shifted by an amount longer than the length of the core segment. The use of affine warping for depth stretching and squeezing produces results that are easily interpretable.

Automation of core-to-log depth matching removes the subjectivity and inconsistency of manual alignment, delivering fast and reproducible correlations that correctly tie high-quality core measurements to continuous logs at the right depths. Accurate core-to-log depth matching improves calibration of porosity-permeability transforms, rock typing, and saturation-height functions, and machine-learning models trained on log-core pairs, which in turn sharpen reservoir static property distributions and reduce uncertainty carried into dynamic reservoir simulation and history matching that support higher confidence field development decisions.

The result of the automatic core-to-log depth matching techniques may then be applied to core measured properties other than the property used for achieving the result described above. The combination of property values evaluated based on both log data and core data allows generating a map of rock layers in the underground formation. This map obtained from the exploratory wells in combination with seismic surveys and other methods of assessing the underground lithology are used to determine whether and where to drill for exploiting the sought-after resources such as (but not limited to) oil and gas.

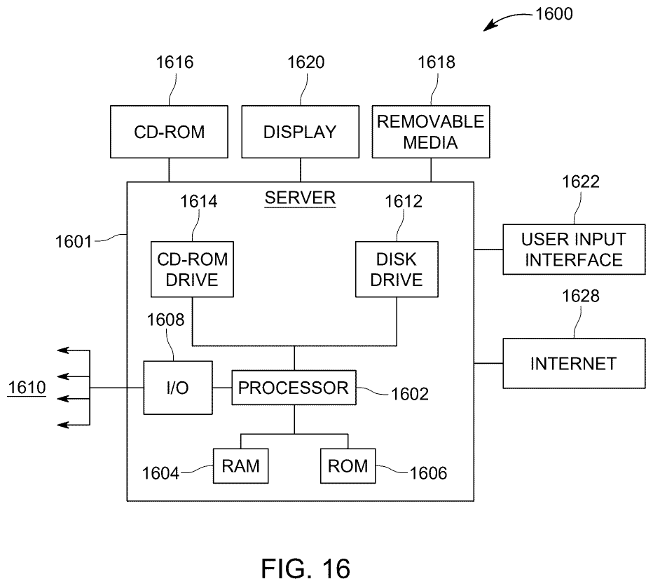

The above-discussed procedures and methods may be implemented in a computing device as illustrated in FIG. 16. Hardware, firmware, software or a combination thereof may be used to perform the various steps and operations described herein. The computing device 1600 is suitable for performing the activities described in the above embodiments and may include a server 1601. Such a server 1601 may include a central processor (CPU) 1602 coupled to a random access memory (RAM) 1604 and to a read-only memory (ROM) 1606. ROM 1606 may also be other types of storage media to store programs, such as programmable ROM (PROM), erasable PROM (EPROM), etc. Processor 1602 may communicate with other internal and external components through input/output (I/O) circuitry 1608 and bussing 1610 to provide control signals and the like. Processor 1602 carries out a variety of functions as are known in the art, as dictated by software and/or firmware instructions.

Server 1601 may also include one or more data storage devices, including hard drives 1612, CD-ROM drives 1614 and other hardware capable of reading and/or storing information, such as DVD, etc. In one embodiment, software for carrying out the above-discussed steps may be stored and distributed on a CD-ROM or DVD 1616, a USB storage device 1618 or other form of media capable of portably storing information. These storage media may be inserted into, and read by, devices such as CD-ROM drive 1614, disk drive 1612, etc. Server 1601 may be coupled to a display 1620, which may be any type of known display or presentation screen, such as LCD, plasma display, cathode ray tube (CRT), etc. A user input interface 1622 is provided, including one or more user interface mechanisms such as a mouse, keyboard, microphone, touchpad, touch screen, voice-recognition system, etc.

Server 1601 may be coupled to other devices, e.g., other data imaging systems. The server may be part of a larger network configuration as in a global area network (GAN) such as the Internet 1628, which allows ultimate connection to various landline and/or mobile computing devices.

As described above, the apparatus 1600 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 1602 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 1602 may be configured to execute instructions stored in the memory device 1604 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Reference throughout the specification all to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

The term “about” is used in this application to mean a variation of up to 20% of the parameter characterized by this term. It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

The disclosed embodiments provide a method for determining surface displacement in an object by masking pixels based on phase closure for enhancing the accuracy of the measurements. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for automated core-to-log depth matching, the method comprising:
pairing a core segment of core property values obtained by analyzing rock samples extracted at core depths from a well and a log segment of log property values obtained from measurements performed with a logging tool at log depths in the well, the core property values and the log property values representing a same subsurface property;
for each pair, determining a block-shifting of the core segment relative to the log segment so as to maximize a similarity metric between the core property values and the log property values; and
performing an affine warping based on a tuned set of hyperparameters to adjust length of at least one of core segments.

2. The method of claim 1, wherein the similarity metric is based a Pearson's correlation coefficient or a Spearman's correlation coefficient.

3. The method of claim 1, wherein the block-shifting includes:
performing a baseline shift for matching a first common-sample-rate depth interval of the core segment with and closest of among common-sample-rate depth intervals of the log segment;
selecting a best lag yielding a highest similarity metric value when the core segment is shifted relative to the log segment by an integer number of common-sample-rate depth intervals; and
validating the best lag based on variabilities of similarity metric values, each variability being calculated using a bootstrap distribution with a predetermined confidence level.

4. The method of claim 3, wherein the validating fails when the highest similarity metric value is less than an upper bound of a similarity metric value of the baseline shift, the upper bound being calculated by adding the variability and the similarity metric value at the baseline shift.

5. The method of claim 3, wherein the validating fails when one or more upper bounds of similarity metric values associated with local peaks exceed a lower bound of the highest similarity metric value of the best lag.

6. The method of claim 3, wherein when the block-shifting causes adjacent core segments to overlap, an overlap length is apportioned to the adjacent core segments proportionally with respective similarity metric value variabilities.

7. The method of claim 1, wherein the performing the affine warping includes:
determining the tuned set of hyperparameters using a skipping cross-validation.

8. The method of claim 1, wherein the affine warping includes:
fitting a warping model using the tuned set of hyperparameters;
performing warping according to the warping model; and
assessing whether the warping significantly improves a core-to-log depth matching output by the block-shifting.

9. The method of claim 1, wherein
the performing the affine warping includes validating the affine warping, and
the method further includes outputting a result of the affine warping when the validating succeeds and outputting a result of the block shifting when the validating fails.

10. The method of claim 1, wherein the pairing comprises:
dividing the core property values into subsets, each subset including values having no more than a predetermined number of core sampling intervals between successive values in the subset, wherein a missing core property value is completed using an adjacent core property value;
calculating margins of each core segment generated using one of the subsets of the core property values;
locating log data segments corresponding to the core data segments; and
resampling each core data segment and corresponding log data segment to have a common-sample-rate depth interval.

11. The method of claim 10, wherein the common-sample-rate depth interval is a minimum among a core sample rate and a log sample rate.

12. The method of claim 1, further comprising at least one of:
applying a result of the core-to-log depth matching to at least another subsurface property obtained from analyzing rock samples extracted at core depths from a well and/or from measurements performed with the logging tool in the well;
generating a multidimensional map of values of the same subsurface property using respective values of the same subsurface property in at least one other well; and
using the result of the automated core-to-log depth matching to plan exploitation of an underground reservoir.

13. A computing system for performing an automated core-to-log depth matching, the system comprising:
an input and output interface configured to receive core property values and log property values and outputting a result of the automated core-to-log depth matching; and
a processor connected to the interface and configured:
to perform an initial pairing of a core segment of the core property values obtained by analyzing rock samples extracted at core depths from a well and a log segment of the log property values obtained from measurements performed with a logging tool at log depths in the well, the core property values and the log property values representing a same subsurface property;
for each pair, to determine a block-shifting of the core segment relative to the log segment so as to maximize a similarity metric between the core property values and the log property values; and
to perform an affine warping based on a tuned set of hyperparameters to adjust length of at least one of core segments.

14. The computing system of claim 13, wherein the processor calculates the similarity metric based on a Pearson's correlation coefficient or a Spearman's correlation coefficient.

15. The computing system of claim 13, wherein the processor determines the block-shifting by:
performing a baseline shift for matching a first common-sample-rate depth interval of the core segment with and closest of among common-sample-rate depth intervals of the log segment;
selecting a best lag yielding a highest similarity metric value when the core segment relative is shifted relative to the log segment by an integer number of common-sample-rate depth intervals; and
validating the best lag based on variabilities of similarity metric values, each variability being calculated using a bootstrap distribution with a predetermined confidence level.

16. The method of claim 15, wherein the validation fails
when the highest similarity metric value is less than an upper bound of a similarity metric value of the baseline shift, the upper bound being calculated by adding the variability and the similarity metric value at the baseline shift.

17. The method of claim 15, wherein the validation fails
when one or more upper bounds of similarity metric values associated with local peaks exceed a lower bound of the highest similarity metric value of the best lag.

18. The computing system of claim 13, wherein the processor performs the affine warping by:
determining the tuned set of hyperparameters using a skipping cross-validation,
fitting a warping model using the tuned set of hyperparameters;
performing warping according to the warping model; and
assessing whether the wrapping significantly improves a core-to-log depth matching output by the block-shifting.

19. The computing system of claim 13, wherein the processor performs the pairing by:
dividing the core property values into subsets, each subset including values having no more than a predetermined number of core sampling intervals between successive values in the subset, wherein a missing core property value is completed using an adjacent core property value;
calculating margins of each core segment generated using one of the subsets of the core property values;
locating log data segments corresponding to the core data segments; and
resampling each core data segment and corresponding log data segment to have a common-sample-rate depth interval.

20. A computer readable recording medium storing executable that when executed by a processor make the processor perform a method for automated core-to-log depth matching, the method comprising:
pairing a core segment of core property values obtained by analyzing rock samples extracted at core depths from a well and a log segment of log property values obtained from measurements performed with a logging tool at log depths in the well, the core property values and the log property values representing a same subsurface property;
for each pair, determining a block-shifting of the core segment relative to the log segment so as to maximize a similarity metric between the core property values and the log property values; and
performing an affine warping based on a tuned set of hyperparameters to adjust length of at least one of core segments.
